(19) United States
(12) Patent Application Publication
(10) Pub. No.: US 2001/0038815 A1
(43) Pub. Date: Nov. 8, 2001

(54) Process for the preparation of a rare-earth metal sulphide of beta form, the rare-earth metal being lanthanum, cerium, praseodymium, samarium or neodymium

(76) Inventors: Sylvain Busnot, Elincourt Sainte-Marguerite (FR); Pierre Macaudiere, Asnieres-Sur-Seine (FR)

Correspondence Address: RHODIA INC., CN-7500, 259 Prospect Plains Road, CRANBURY, NJ, 08512, US

(21) Appl. No.: 09/864,956

(22) Filed: May 24, 2001

Related U.S. Application Data
(63) Continuation of application No. 09/308,404, filed on Aug. 16, 1999.

(30) Foreign Application Priority Data
Nov. 19, 1996 (FR) 96/14058

(51) Int. Cl. C01F 17/00

(52) U.S. Cl. 423/263; 106/31.9; 106/401

(57) ABSTRACT

The invention concerns the use of a beta rare earth sulphide as coloring pigment and its method of preparation. A beta rare-earth sulphide is used, the rare earth being lanthanum, cerium, praseodymium, samarium or neodymium. The sulphide consists of whole crystallites forming medium-sized aggregates of not more than 1.5 μm. The method of preparation of this rare earth sulphide is characterized in that a rare earth compound is reacted with at least one sulphidizing gas selected among hydrogen sulphide or carbon sulphide. The pigment can be part of compositions of the following types: plastic, paint, surface coating, rubber, ceramic, glazing, paper, ink, cosmetic products, dyes, leather, laminated coating or other types of compositions with a base of at least one mineral binder or obtained therefrom.

The present invention relates to the use, as colouring pigment, of a rare-earth metal sulphide of beta form and to its process of preparation.

Inorganic colouring pigments are already widely used in many industries, in particular in paints, plastics and ceramics. In such applications, the properties, which are, inter alia, thermal and/or chemical stability, dispersibility (ability of the product to disperse correctly in a given medium), compatibility with the medium to be coloured, intrinsic colour, colouring power and opacifying power, all constitute particularly important criteria to be taken into consideration in the choice of a suitable pigment.

Most of the inorganic pigments which are suitable for applications such as above and which are actually used at the present time on an industrial scale present a problem, however. This is because they generally make use of metals (cadmium, lead, chromium and cobalt in particular) whose use is becoming increasingly severely regulated, or even banned, by legislation in many countries, this being on account of their supposed very high toxicity.

It is thus seen that there is a great need for novel inorganic substitution pigments.

The object of the present invention is to provide such pigments, in the range of reds in particular and more particularly in the range of Bordeaux red.

According to a first embodiment, the present invention provides a process for the preparation of a rare-earth metal sulphide of beta form, the rare-earth metal being lanthanum, cerium, praseodymium, samarium or neodymium, in which a carbonate or a hydroxycarbonate of the rare-earth metal is reacted with hydrogen sulphide.

According to a second embodiment, the process is characterized in that a compound of the rare-earth metal is reacted with a sulphurizing gaseous mixture based on hydrogen sulphide and on carbon disulphide.

The present invention applies to the preparation of a lanthanum, cerium, praseodymium, samarium or neodymium sulphide as well as mixed sulphides, that is to say sulphides of two or more rare-earth metals of the group given above. Consequently, everything described subsequently for a simple sulphide also applies to mixed sulphides.

In the case of the first embodiment, the process is characterized in that a carbonate or a hydroxycarbonate of the rare-earth metal is reacted with hydrogen sulphide.

According to the second embodiment of the invention, a mixture of two gases is used. It has been noticed that it is possible to modify the colour of the sulphide by varying the oxygen content of this sulphide. This oxygen content can be modified by varying the carbon disulphide content in the gaseous mixture. Thus, all the other process parameters otherwise being equal, a high carbon disulphide content promotes the production of sulphides with low oxygen contents, that is to say of products with lighter colours of the light Bordeaux type, for example, whereas a higher hydrogen sulphide content makes it possible to obtain products with higher oxygen concentrations and thus with darker colours.

The sulphurizing gas or mixture of sulphurizing gases can be employed with an inert gas, such as argon or nitrogen.

The rare-earth metal compound used for the reaction, in this second embodiment, is preferably a carbonate or a hydroxycarbonate. Mention may also be made of nitrates. A rare-earth metal oxide can also be used.

The sulphurization reaction is generally carried out at a temperature of from 600 to 1000° C., preferably 600 to 800° C., in particular at 800° C. or in the region of this temperature.

The duration of the reaction corresponds to the time necessary to obtain the desired sulphide, typically from one to four hours.

On conclusion of the heating, the sulphide formed can be recovered. If it is desired to obtain a product with a finer particle size, the latter can be deagglomerated. Deagglomeration under mild conditions, for example a wet milling or a milling of the air jet type under mild conditions, makes it possible to obtain a sulphide exhibiting, in particular, a mean aggregate size of not more than 1.5 μm.

The rare-earth metal sulphide obtained by the processes of the invention in a sulphide which exhibits the beta crystallographic form. Beta form, as used herein, is understood to mean a compound of formula Ce₁₀S₁₄OₓS₁₋ₓ in which x is between 0 and 1, 0 being excluded, crystallizing in the quadratic system, I 4₁/acd space group.

A characteristic of the sulphide obtained by the processes of the invention is that it is composed of whole crystallites. These crystallites form aggregates and these aggregates constitute the powder which is produced by the process “Whole crystallite” is understood to mean a crystallite which has not been broken or shattered. Crystallites can in fact be shattered or broken during milling. Scanning electron microscopy photos of the product of the invention make it possible to show that the crystallites which constitute it have generally not been shattered.

The aggregates constituting the sulphide usually exhibit a mean size of not more than 1.5 μm. This mean size is generally not more than 1 μm and more particularly not more than 0.8 μm. Throughout the description, the characteristics of size and of particle size distribution are measured by the laser diffraction technique, using a particle sizer of the Cilas HR 850 type (distribution by volume).

It should also be noted that the sulphide obtained by the processes of the invention can be deagglomerated. It may thus not be provided directly in the form of aggregates with a mean size within the values given above. In this case, the aggregates may be agglomerated and/or slightly sintered and have a size greater than these values. Simple deagglomeration under mild conditions makes it possible to obtain aggregates with a mean size of not more than 1.5 μm or within the ranges given above.

According to a specific embodiment, the sulphide is provided in the form of a pure phase, the single beta phase as defined above.

The sulphide obtained by the processes of the invention can, in addition, exhibit a variable oxygen content. This content, expressed as weight of oxygen with respect to the weight of the entire sulphide, should not be more than 0.8%.

In the case where the rare-earth metal is cerium, the sulphide generally exhibits a Bordeaux red colour. According to a specific embodiment, the cerium sulphide exhibits a chromaticity coordinate L* of less than 40 and a b*/a* ratio of less than 0.6. The chromaticity coordinates L*, a* and b* are given here (and throughout the description) in the CIE 1976 system (L*, a* and b*), as defined by the Commission Internationale d'Eclairage [International Lighting Commission] and listed in the Recueil des Normes Francaises [Compendium of French Standards] (AFNOR), colorimetric colour No. X08-12, No. X08-14 (1983). They are determined by means of a colorimeter sold by the company Pacific Scientific. The nature of the illuminant is D₆₅. The observation surface is a circular pellet with a surface area of 12.5 cm². The observation conditions correspond to viewing under an aperture angle of 10°. In the measurements given, the specular component is excluded.

Various alternative forms of the invention will now be described.

According to a first alternative form, the sulphide, as described above, additionally comprises a layer based on at least one transparent oxide, which layer is deposited at its surface or its periphery. Reference may also be made, as regards a product of this type to French Patent Application FR-A-2,703,999.

This peripheral layer coating the sulphide may not be perfectly continuous or homogeneous. However, preferably, the sulphides according to this embodiment comprise a transparent oxide coating layer which is uniform and of controlled thickness and which does not detrimentally affect the original colour of the sulphide before coating.

“Transparent oxide” is understood to mean an oxide which, once deposited on the sulphide in the form of a more or less fine film, only absorbs light rays in the visible region to a very small extent or not at all and which does not mask, or only very slightly masks, the original intrinsic colour of the said sulphide. In addition, it should be noted that the term “oxide” as used herein should be understood as also covering oxides of the hydrated type.

These oxides, or hydrated oxides, can be amorphous and/or crystalline.

Mention may more particularly be made, as examples of such oxides, of silicon oxide (silica), aluminium oxide (alumina), zirconium oxide (zirconia), titanium oxide, zirconium silicate ZrSiO₄ (zircon) and rare-earth metal oxides. According to a preferred alternative form, the coating layer is based on silica. More advantageously still, this layer is essentially, and preferably solely, composed of silica.

According to another alternative form, the sulphide can additionally comprise fluorine atoms.

In this case, reference may also be made, as regards the arrangement of the fluorine atoms, to French Patent Application PR-A-2,706,476.

The fluorinated sulphide can exhibit at least one of the following characteristics:

the fluorine atoms are distributed along a concentration gradient decreasing from the surface to the core of the said sulphide;

the fluorine atoms are mainly distributed at the outer periphery of the sulphide. Outer periphery is understood to mean, in this instance, a thickness of material, measured from the surface of the particle, of the order of a few hundreds angstroms. In addition, “mainly” is understood to mean that more than 50% of the fluorine atoms present in the sulphide are found in the said outer periphery;

the percentage by weight of fluorine atoms present in the sulphide does not exceed 10% and preferably 5%;

the fluorine atoms are present in the form of fluorinated or sulphofluorinated compounds, in particular in the form of rare-earth metal fluorides or of rare-earth metal sulphofluorides (thiofluorides).

Of course, the present invention combination of embodiments which have been described above. Thus, it is possible to envisage a sulphide comprising an oxide layer and, in addition, comprising fluorine atoms.

Methods for the preparation of the sulphides according to these alternative forms will now be described.

For the first alternative form described above, that is to say for the sulphide exhibiting a layer of a transparent oxide, the preparation process can consist in bringing together the sulphide, as it has been obtained after the sulphurization reaction, and a precursor of the layer-forming transparent oxide, and in precipitating this oxide. The processes for precipitating the oxides and the precursors to be used are described in particular in FR-A-2,703,999.

In the case of silica, mention may be made of the preparation of silica by hydrolysis of an alkyl silicate, a reaction mixture being formed by mixing water, alcohol, the sulphide, which is then suspended, and optionally a base, followed by the introduction of the alkyl silicate, or alternatively a preparation by reaction of the sulphide, of a silicate, of the alkali metal silicate type, and of an acid.

In the case of a layer based on alumina, the sulphide, an aluminate and an acid can be reacted, whereby alumina is precipitated. This precipitation can also be obtained by bringing together and by reacting the sulphide, an aluminium salt and a base.

Finally, the alumina can be formed by hydrolysis of an aluminium alkoxide.

As regards titanium oxide, it can be precipitated by introducing, into an aqueous suspension of the sulphide according to the invention, a titanium salt, such as TiCl₄, TiOCl₂ or TiOSO₄, on the one hand, and a base, on the other hand. It is also possible to carry out the preparation, for example, by hydrolysis of an alkyl titanate or precipitation of a titanium sol.

Finally, in the case of a layer based an zirconium oxide, it is possible to carry out the preparation by cohydrolysis or coprecipitation of a suspension of the sulphide in the presence of an organometallic zirconium compound, for example a zirconium alkoxide, such as zirconium isopropoxide.

The process for the preparation of the sulphide according to the second alternative form, a sulphide comprising fluorine atoms, employs a fluorination.

The fluorination can be carried out according to any technique known per se bringing together the sulphide, as it has been obtained after the sulphurization reaction, and a fluorinating agent.

In particular, the fluorinating agent can be liquid, solid or gaseous. Preferably, the fluorination is carried out under treatment conditions where the fluorinating agent is liquid or gaseous.

Mention may more particularly be made, as examples of fluorinating agents which are suitable for the implementation of the treatment according to the invention, of fluorine F₂, alkali metal fluorides, ammonium fluoride, rare gas fluorides, nitrogen fluoride NF₃, boron fluoride BF₃, tetrafluoromethane or hydrofluoric acid HF.

In the case of a treatment under a fluorinating atmosphere, the fluorinating agent can be used pure or diluted in a neutral gas, for example nitrogen.

The reaction conditions are preferably chosen so that the said treatment only brings about fluorination at the surface of the sulphide (mild conditions). In this respect, carrying out the fluorination to the core of the sulphide does not produce results which are substantially improved with respect to an essentially surface fluorination. In practice, it is possible to experimentally monitor and control the degree of progression of the fluorination reaction, for example by measuring the change in the increase in mass of the materials (increase in mass brought about by the gradual introduction of fluorine).

The fluorinating agent can more particularly be ammonium fluoride.

As has been indicated above, it is possible to envisage preparing a sulphide which combines the constituent characteristics of the various embodiments: the layer of oxide and the presence of fluorine atoms. In order to obtain such combinations the preparation processes which have just been described are combined.

Thus, the fluorination treatment can be carried out in a first stage, and, then, in a second stage, the sulphide thus treated and a precursor of the transparent oxide are brought into contact, and the transparent oxide is precipitated on the said sulphide.

Another process can also be envisaged. In this case, in a first stage, the sulphide and a precursor of the transparent oxide are brought into contact and then the transparent oxide is precipitated on the said sulphide, and, finally, in a last stage, the fluorination treatment is carried out.

The sulphide of the invention such as obtained after reaction with the sulphurizing gaz or mixture can be treated in order to deposit on it a zinc precursor. This deposit can be made by reaction of a zinc precursor with aqueous ammonia or an ammonium salt. Reference may be made for this treatment to French patent application FR-A-2741629 the teaching of which is incorporated here. Some essential elements of this treatment are recalled here below.

The zinc precursor may be a zinc oxide or hydroxide which is used in suspension. This precursor may also be a zinc salt, preferably a soluble salt. This may be a salt of inorganic acid such as a chloride, or alternatively a salt of organic acid such as an acetate.

For the deposit of the zinc compound, the sulphide, the zinc precursor, the aqueous ammonia and/or the ammonium salt are placed in contact in the presence of an alcohol. The alcohol used is generally chosen from aliphatic alcohols such as, for example, butanol or ethanol. The alcohol may in particular be introduced with the zinc precursor in the form of an alcoholic zinc solution.

According to another advantageous variant the sulphide, the zinc precursor, the aqueous ammonia and/or the ammonium salt are placed in contact in the presence of a dispersing agent. The aim of this dispersing agent is to prevent agglomeration of the particles forming the support during their placing in suspension for the treatments described above. It also makes it possible to work in more concentrated media. It promotes the formation of a homogeneous layer of transparent oxide over all of the particles.

This dispersing agent may be chosen from the group of agents which disperse by a steric effect, and in particular nonionic organosoluble or water-soluble polymers. Dispersing agents which may be mentioned are cellulose and its derivatives, polyacrylamides, polyethylene oxides, polyethylene glycols, polyoxyethylenated polyoxypropylene glycols, polyacrylates, polyoxyethylenated alkylphenols, polyoxyethylenated long-chain alcohols, polyvinyl alcohols, alkanolamides, dispersing agents of the polyvinylpyrrolidone type and compounds based on xanthan gum.

The sulphide described has good colouring power and covering power and, for this reason, is suitable for the colouring of numerous materials, such as plastics, paints and others.

More specifically, it can be used in the colouring of polymers for plastics which can be of the thermoplastic or thermosetting type.

Mention may be made, as thermoplastic resins capable of being coloured according to the invention, purely by way of illustration, of poly(vinyl chloride), poly(vinyl alcohol) polystyrene, styrene-butadiene, styrene-acrylonitrile and acrylonitrile-butadiene-styrene (A.B.S.) copolymers, acrylic polymers, in particular poly(methyl methacrylate), polyolefins, such as polyethylene, polypropylene, polybutene or polymethylpentene, cellulose derivatives, such as cellulose acetate, cellulose acetobutyrate or ethylcellulose, or polyamides, including polyamide-6,6.

As regards the thermosetting resins for which the sulphide is also suitable, mention may be made, for example, of pbenoplasts, aminoplasts, in particular urea-formaldehyde or melamine-formaldehyde copolymers, epoxy resins and thermosetting polyesters.

The sulphide can also be employed in special polymers, such as fluorinated polymers, in particular polytetrafluoroethylene (P.T.F.E.), polycarbonates, silicone elastomers or polyimides.

In this specific application for the colouring of plastics, the sulphide can be employed directly in the form of powders. It is also possible, preferably, to employ it in a predispersed form, for example as a premix with a portion of the resin, or in the form of a concentrated paste or of a liquid, which makes it possible to introduce it at any stage in the manufacture of the resin.

Thus, the products according to the invention can be incorporated in plastics, such as those mentioned above, in a proportion by weight generally ranging either from 0.01 to 5% (relative to the final product) or from 20 to 70%, in the case of a concentrate.

The products of the invention can also be used in the field of paints and varnishes and more particularly in the following resins: alkyd resins, the commonest of which is glyceryl phthalate resin; resins modified with long or short oil; acrylic resins derived from esters of acrylic acid (methyl or ethyl) and of methacrylic acid, optionally copolymerized with ethyl, 2-ethylhexyl or butyl acrylate; vinyl resins, such as poly(vinyl acetate), poly(vinyl chloride), poly(vinyl butyral), poly(vinyl formal), and vinyl chloride and vinyl acetate or vinylidene chloride copolymers; phenolic or aminoplast resins, generally modified; polyester resins; polyurethane resins; epoxy resins; or silicone resins.

The products are generally employed in the proportion of 5 to 30% by weight of the paint and of 0.1 to 5% by weight of the varnish.

In addition, the products according to the invention are also suitable for applications in the rubber industry, in particular in floor surfacings, in the paper and printing inks industry, in the field of cosmetics, and any other uses, such as dyes, in leathers, for finishing the latter, and laminated coatings for kitchens and other work surfaces, ceramics and glazes.

The products of the invention can also be used in the colouring of materials based on or obtained from, at least one inorganic binder.

This inorganic binder can be chosen from, typically, hydraulic binders, air-cured binders, plaster and binders of the anhydrous or partially hydrated calcium sulphate type.

“Hydraulic binders” is understood to mean substances having the property of setting and of hardening after addition of water with the formation of water-insoluble hydrates. The products of the invention apply very particularly to the colouring of cements and, of course, of the concretes manufactured from these cements by addition to the latter of water, sand and/or gravel.

In the context of the present invention, the cement can be, for example, of the aluminous type i.e. any cement containing a high proportion either of alumina as such or of aluminate or of both. Mention may be made, as examples, of cements based on calcium aluminate, in particular those of the Secar type.

The cement can also be of the silicate type and more particularly based on calcium silicate. Examples which may be given are Portland cements and, in cements of this type, quick-setting or very-quick-setting Portland cements, white cements, those which are resistant to sulphates and those comprising blast furnace slag and/or fly ash and/or meta-kaolin.

Mention may also be made of cements based on calcium sulphate hemihydrate and magnesia cements, known as Sorel cements.

The products of the invention can also be used for colouring air-cured binders, that is to say binders which harden in the open air by the action of CO₂, of the calcium or magnesium oxide or hydroxide type.

Finally, the products of the invention can be used for colouring plaster and binders of the anhydrous or partially hydrated calcium sulphate type (CaSO₄ and CaSO₄.½H₂O).

The invention thus provides coloured compositions of a material, in particular of the plastics, paints, varnishes, rubbers, ceramics, glazes, papers, inks, cosmetic products, dyes, leathers or laminated coatings type or of the type based on or obtained from at least one inorganic binder, which comprise, as colouring pigment, a sulphide as defined above or obtained by processes of the type described above.

The following Examples further illustrate the present invention. In these Examples, the particle size was determined according to the abovementioned technique. The measurement was carried out on a dispersion of the product in an aqueous solution containing 0.05% by weight of sodium hexametaphosphate which has been subjected beforehand to treatment with an ultrasonic probe (probe with a tip with a diameter of 13 mm, 20 kHz, 120 W) for 3 minutes.

### EXAMPLE 1

### Synthesis of β-Ce₁₀S₁₄O_{0.17}S_{0.03} (Light-red Sulphide)

Procedure

16 g of cerium hydroxycarbonate (Ce(OH)CO₃), containing 70.7% of CeO₂, were calcined under a flow of H₂S (flow rate=10 l/h) and of CS₂ (flow rate=1.4 l/h) according to the following temperature profile: temperature rise to 800° C. at the rate of 8° C./min, then a stationary phase of 1 hour at this temperature.

Results

13 g of product with the formula given above (a single phase present according to the X-ray plates) are obtained with an oxygen content of 0.15% by mass (determined by virtue of the unit cell parameter).

The particle size obtained is 0.74 μm (σ/m=0.49).

The colours, determined in the CIE Lab system, are:

L*/a*/b*=38.9/36.3/16.7

The absorptions at 400 and 700 nm are as follows:

R400/R700=5.06/65.63.

10 g of the pigment thus synthesized are mixed in a rotating vessel with 2 kg of a reference polypropylene Eltex® PHV 001. The mixture is then injected at 220° C. using a Kapsa injection moulding machine, model Protoject 10/10, with a cycle of 41 s. The mould is maintained at a temperature of 35° C.

A parallelepipedal double-thickness (2 and 4 mm) test sample is thus obtained.

It is observed that the pigment is well dispersed. The chromaticity coordinates and the absorptions, measured on the thick part of the plate, are as follows:

L*/a*/b*=33.5/39.6/20.6

R400/R700=2.4/60.2.

### EXAMPLE 2

### Synthesis of β-Ce₁₀S₁₄O_{0.8}S_{0.2} (Dark-red Sulphide)

Procedure

14 g of cerium hydroxycarbonate (Ce(OH)CO₃), containing 70.7% of CeO₂, were calcined under a flow of H₂S (flow rate=10 l/h) according to the following temperature profile: temperature rise to 800° C. at the rate of 8° C./min, then a stationary phase of 3 hours at this temperature.

Result

11.2 g of product with the formula given above (a single phase present according to the X-ray plates) are obtained with an oxygen content of 0.69% by mass (determined by virtue of the unit cell parameter).

The particle size obtained is 0.76 μm (σ/m=0.44).

The colours and the absorptions, determined in the CIE Lab system, are:

L*/a*/b*=36.1/27.4/12

R400/R700=5.06/64.35.

After injection in polypropylene under the conditions of Example 1, the colours and absorptions become:

L*/a*/b*=29.7/31.4/16.4

R400/R700=2.05/9.5.

The following examples concern some products which have been submitted, after their preparation, to complementary treatment to obtain a layer of a transparent oxide, to deposit zinc or fluorine.

The treatment to deposit the layer of oxide and for the introduction of zinc is as follows.

The polyvinylpyrrolidone (PVP) is dissolved in ethanol.

The fluorinated cerium sulphide is added to this solution, then the aqueous ammonia solution and lastly the zinc precursor. The ethyl silicate is introduced continuously over two hours. After introduction of the ethyl silicate, the mixture is matured for two hours. The particles thus obtained are washed with ethanol by filtration and then dried at 50° C. for twelve hours.

### EXAMPLE 3

This example concerns the product of example 2

The reactants are used in the following proportions:

| | g of product/kg of suspension |
|---|---|
| β-Ce₁₀S₁₄O_{0.8}S_{0.2} | 200 |
| 95% Ethanol | 643 |
| Aqueous ammonia (32%) | 100 |
| Zinc acetate | 20 |
| Ethyl silicate | 32 |
| PVP K10 (Aldrich company) | 5 |
| Mw = 10000 | |

The used cerium sulphide was fluorinated beforehand as follows. 10 g of product are introduced into 100 ml of ammonium fluoride solution (5 % by mass with respect to β-Ce₁₀S₁₀S₁₄O_{0.8}S_{0.2}).

The pH of the mixture is brought to 8 by addition of aqueous ammonia solution and the medium is left stirring for one hour. The product is next filtered off and then dried in a desiccator under vacuum.

The product thus obtained is treated under the operating conditions given above, using aqueous ammonia.

The product obtained has the following chromatic coordinates after injection into polypropylene:

L*/a*/b*=36/20/10

### EXAMPLE 4

This example concerns the product of example 1

The reactants are used in the following proportions:

| | g of product/kg of suspension |
|---|---|
| β-Ce₁₀S₁₄O_{0.17}S_{0.83} | 200 |
| 95% Ethanol | 643 |
| Aqueous ammonia (32%) | 100 |
| Zinc acetate | 32 |
| Ethyl silicate | 32 |
| PVP K40 (Aldrich company) | 5 |
| Mw = 10000 | |

The used cerium sulphide was fluorinated beforehand as follows. 10 g of product are introduced into 100 ml of ammonium fluoride solution (5% by mass with respect to β-Ce₁₀S₁₄O_{0.17}S_{0.83}).

The pH of the mixture is brought to 8 by addition of aqueous ammonia solution and the medium is left stirring for one hour. The product is next filtered off and then dried in a desiccator under vacuum.

The product thus obtained is treated under the operating conditions given above, using aqueous ammonia.

The product obtained has the following chromatic coordinates after injection into polypropylene:

L*/a*/b*=38/33/15

1. Process for the preparation of a rare-earth metal sulphide of beta form, the rare-earth metal being lanthanum, cerium, praseodymium, samarium or neodymium, characterized in that a carbonate or a hydroxycarbonate of the rare-earth metal in reacted with hydrogen sulphide.

2. Process for the preparation of a rare-earth metal sulphide of beta form, the rare-earth metal being lanthanum, cerium, praseodymium, samarium our neodymium characterized in that a compound of the rare-earth metal is reacted with a sulphurizing gaseous mixture of hydrogen sulphide and on carbon disulphide.

3. Process according to claim 2, characterized in that the rare-earth metal compound is a carbonate or a hydroxycarbonate.

4. Process according to claim 2 or 3, characterized in that the oxygen content of the sulphide prepared is modified by varying the carbon disulphide content in the gaseous mixture.

5. Process according to any one of the preceding claims characterized in that the reaction is carried out at a temperature of 600° C. to 800° C.

6. Process according to any one of the preceding claims characterized in that the sulphide obtained after reaction with sulphurizing gaz or mixture is brought into contact with a precursor of a transparent oxide such that this oxide is precipitated on the sulphide.

7. Process according to any one of claims 1 to 6 characterized in taht the sulphide obtained after reaction with the sulphurizing gaz or mixture is brought into contact with a fluorinating agent.

8. Process according to any one of claims 1 to 7 characterized in that a zinc compound is deposited on the sulphide obtained after reaction with the sulphurizing gaz or mixture by reaction of a zinc precursor with aqueous ammonia or an ammonium salt.

9. Use as colouring pigment of a sulphide obtained by the process according to any one of the preceding claims.

10. Compositions of colored matter such as plastics, paints, varnishes, rubbers, ceramics, glazes, papers, inks, cosmetic products, dyes, leathers or laminated coatings type or of the type based on or obtained from at least one inorganic binder, characterized in that they are prepared by using a sulphide obtained by the process according to claims 1 to 8.
